(19) United States
(12) Patent Application Publication
(10) Pub. No.: US 2026/0089286 A1
(43) Pub. Date: Mar. 26, 2026

(54) STORAGE MEDIUM STORING APPLICATION PROGRAM, CONTROL METHOD, AND INFORMATION PROCESSING APPARATUS

(71) Applicant: CANON KABUSHIKI KAISHA, Tokyo (JP)

(72) Inventor: TSUBASA OCHIAI, Chiba (JP)

(21) Appl. No.: 19/335,665

(22) Filed: Sep. 22, 2025

(30) Foreign Application Priority Data
Sep. 24, 2024 (JP) 2024-165126

(51) Int. Cl. H04N 1/58; G06F 3/12

(52) U.S. Cl. CPC H04N 1/58; G06F 3/1207; G06F 3/1253; G06F 3/1287

(57) ABSTRACT

A non-transitory computer-readable storage medium strong an application program supporting a standard driver that is provided from a provider of an operating system and is incorporated in the operating system in advance. A setting reception screen for receiving a setting of trapping processing for image data is displayed. An image forming apparatus is instructed to execute the trapping processing based on the setting received on the setting reception screen.

### BACKGROUND

### Field of the Technology

The present disclosure relates to a storage medium storing an application program, a control method, and an information processing apparatus.

### Description of the Related Art

To a printing apparatus that performs printing, a host computer (information processing apparatus) that is capable of processing information between the same and the printing apparatus is communicably connected. As control software for controlling the printing apparatus, for example, a printer driver installed from the printing apparatus into the host computer is used. With this printer driver, it is possible to provide a print instruction from the host computer to the printing apparatus. In the host computer, an operating system (hereinafter referred to as the “OS”) as basic software is installed in advance. The printer driver is configured according to specifications defined by the OS and can operate when called from the OS. Further, the printer driver is different for each vendor that supplies a printing apparatus, i.e. a model-specific printer driver which is suitable on a printing apparatus basis.

In recent years, in Windows (registered trademark), a standard class driver (hereinafter sometimes referred to as the “standard driver”) is provided, which can be commonly used even for printing apparatuses supplied from a plurality of different vendors, respectively. Such a standard driver is incorporated in the OS in advance. Then, by connecting a desired printing apparatus to a host computer having the OS incorporating the standard driver, the standard driver can be used. This makes it possible to omit installation of a model-specific printer driver. Further, with the standard driver, a print function of the printing apparatus can be designated and used according to Print Device Capabilities (hereinafter referred to as the “PDC”) generated based on information acquired from the printing apparatus. This makes it possible to designate a print function on a printing apparatus basis by one standard driver. A function extension application (hereinafter sometimes referred to as the “extension application”) for extending a function can be associated with the standard driver. The extension application is provided from each vendor. Therefore, it is difficult to execute functions of the extension application only with the standard driver.

Japanese Laid-Open Patent Publication No. 2021-33526 discloses an apparatus having a first application for generating image data and a second application for causing a user to make print settings used for printing the image data. The second application is capable of setting an item which cannot be set by the first application. Examples of this item include color printing, poster printing, and bookbinding printing.

As described above, the printer driver is a model-specific printer driver which is different for each vendor that supplies a printing apparatus, i.e. which is suitable on a printing apparatus basis. This printer driver has a function of causing, when a print instruction is provided to a printing apparatus, the printing apparatus to execute trapping processing when this printing is performed. The trapping processing refers to processing for extending, e.g. in a case where a black character is present on a cyan background, part of the cyan background so as to cause the black character to be overlapped on the cyan background to thereby prevent a white blank space from being caused even in a case where one of the color plates is shifted. However, there is a problem that, with the standard driver, when providing a print instruction to a printing apparatus, it is impossible to cause the printing apparatus to execute the trapping processing when this printing is performed.

### SUMMARY

The present disclosure is directed to providing a mechanism that is capable of causing an image forming apparatus to execute trapping processing.

In a first aspect of the present disclosure, there is provided a non-transitory computer-readable storage medium storing an application program supporting a standard driver that is provided from a provider of an operating system and is incorporated in the operating system in advance, wherein the application program causes a computer to execute a display control step for displaying a setting reception screen for receiving a setting of trapping processing for image data, and an instruction step for instructing an image forming apparatus to execute the trapping processing based on the setting received on the setting reception screen.

In a second aspect of the present disclosure, there is provided a non-transitory computer-readable storage medium storing an application program supporting a standard driver that is provided from a provider of an operating system and is incorporated in the operating system in advance, wherein the application program causes a computer to execute a display control step for displaying a setting reception screen for receiving a setting of trapping processing for image data, a generation control step for generating image data on which the trapping processing has been performed based on the setting received on the setting reception screen, and a transmission step for transmitting the image data generated in the generation control step to an image forming apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a printing system according to a first embodiment.

FIGS. 2A-A and 2A-B are block diagrams each showing a software configuration of the printing system.

FIG. 2B is a flowchart of an imaging process performed by a printing apparatus.

FIG. 3 is a flowchart of a trapping process in a step (subroutine) of the flowchart in FIG. 2B.

FIGS. 4A to 4C are diagrams useful in explaining an effect of trapping processing.

FIGS. 5A-A to 5A-C are diagrams each showing an example of a screen displayed on a display section of the printing system.

FIG. 5B is a diagram showing a variation of the screen displayed on the display section of the printing system.

FIG. 6 is a flowchart of a process performed by a print function-extending unit for editing print function information.

FIG. 7 is a diagram showing an example of a list of capabilities information of the printing apparatus.

FIG. 8 is a diagram showing an example of a list of print functions supported by an extension application.

FIG. 9 is a diagram showing an example of a list of capabilities information of general-purpose print software.

FIG. 10 is a sequence diagram showing a process executed between a drawing application, the general-purpose print software, the extension application, and the printing apparatus, after the drawing application receives print settings.

FIG. 11 is a block diagram showing a software configuration of a printing system according to a second embodiment.

FIG. 12 is a flowchart of a process performed by a print function-extending unit for editing print function information.

FIG. 13 is a diagram showing an example of a list of the capabilities information of the printing apparatus.

FIG. 14 is a sequence diagram showing a process executed between the drawing application, the general-purpose print software, the extension application, and the printing apparatus, after the drawing application receives print settings.

FIG. 15A is a block diagram showing a software configuration of a printing system according to a third embodiment.

FIG. 15B is a flowchart of an imaging process performed by the printing apparatus.

FIG. 16 is a diagram showing an example of a list of trapping exclusion setting information.

FIG. 17 is a sequence diagram showing a process executed between the drawing application, the general-purpose print software, the extension application, and the printing apparatus, after the drawing application receives print settings.

FIG. 18 is a diagram showing an example of a screen displayed on the display section of the printing system.

FIG. 19 is a sequence diagram according to a fourth embodiment, which shows a process executed between the drawing application, the general-purpose print software, the extension application, and the printing apparatus, after the drawing application receives print settings.

FIGS. 20A to 20C are diagrams each showing an example of a screen displayed on the display section of a printing system.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of the configuration of the present disclosure can be replaced with desired components which can exhibit the same functions. Further, desired components can be added. Further, two or more desired components (features) of the embodiments can be combined.

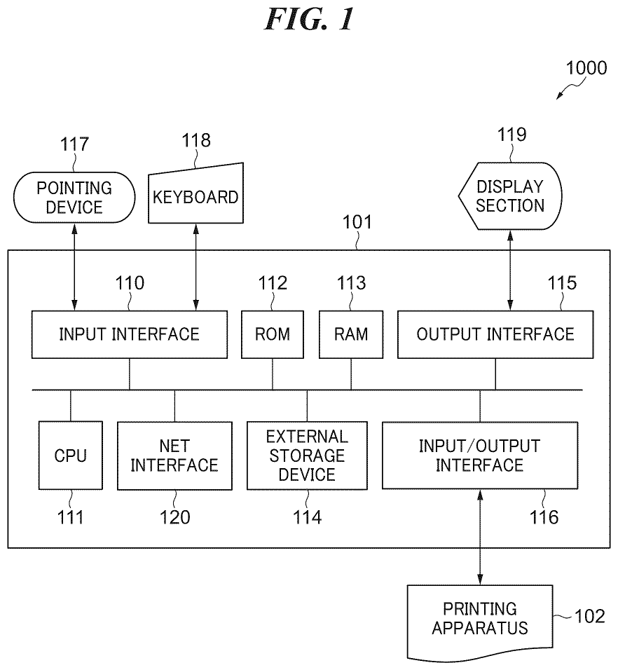

A first embodiment will be described below with reference to FIGS. 1 to 10.

FIG. 1 is a block diagram showing a hardware configuration of a printing system according to the first embodiment. As shown in FIG. 1, the printing system, denoted by reference numeral 1000, includes a host computer 101, a printing apparatus 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that although, as the host computer 101, for example, a desktop-type personal computer can be used, this is not limitative, but, for example, any of a laptop-type personal computer, a tablet terminal, and a smartphone can be used.

The CPU 111 is a computer that executes e.g. programs stored in the ROM 112 or the external storage device 114. With this, the CPU 111 is capable of executing processing steps (control method), described hereinafter. In the ROM 112, an initialization program is stored. In the external storage device 114, an application program group, an OS, print data generation software, and a variety of other data items are stored. Note that in the present embodiment, as the OS, Windows (registered trademark) 11 of Microsoft (registered trademark) has been installed in the host computer 101. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a print setting screen 500A and a detailed setting screen 500C, described hereinafter, are displayed. The NET interface 120 performs control to transfer data to and from an external apparatus via a network. To the input/output interface 116, the printing apparatus 102 is connected. This enables the host computer 101 to communicate with the printing apparatuses 102 of a plurality of makers, i.e. process information between the host computer 101 and the printing apparatuses 102 of the plurality of makers, regardless of the maker of the printing apparatus 102.

As the printing apparatus 102, for example, an image forming apparatus, such as a multi-function peripheral (MFP) having a plurality of functions, such as copy, print, and FAX functions, can be used, but this is not limitative. Further, printing performed by the printing apparatus 102 is printing by an electrophotographic method in the present embodiment but is not limited to this, and for example, printing by an inkjet method or the like can be performed. Further, although in the present embodiment, the host computer 101 and the printing apparatus 102 are configured as the apparatuses separate from each other, this is not limitative. For example, the host computer 101 and the printing apparatus 102 can be configured as an integrated apparatus.

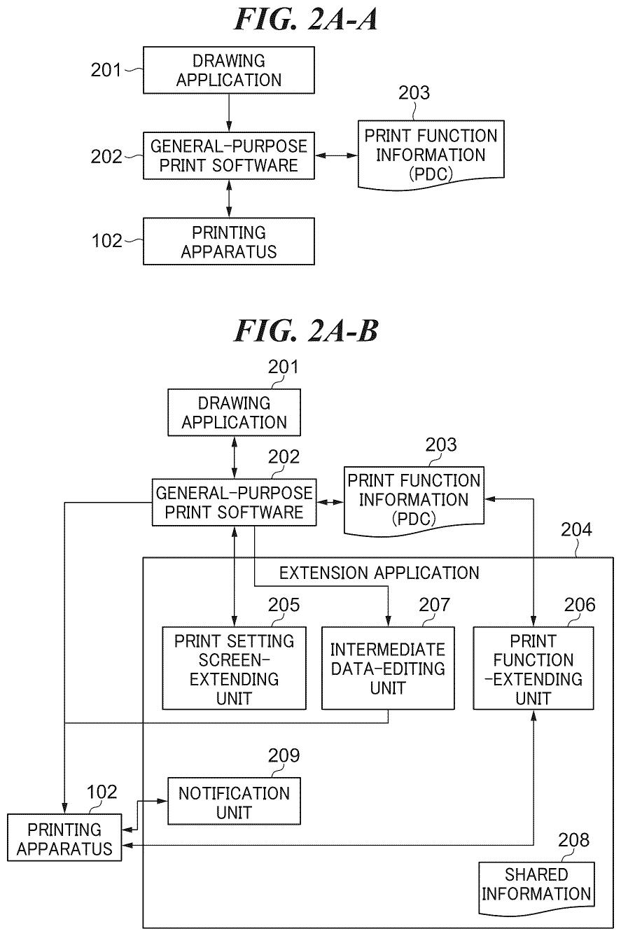

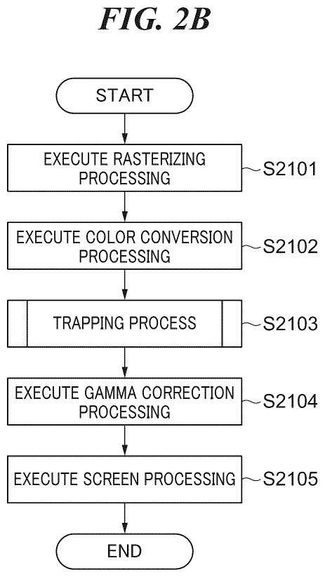

FIGS. 2A-A and 2A-B are block diagrams each showing a software configuration of the printing system 1000. FIG. 2A-A is a diagram showing a general configuration in a case where an extension application (application program) 204 is not associated with general-purpose print software (standard driver) 202 and the printing apparatus 102. FIG. 2A-B is a diagram showing a configuration in a case where the extension application 204 is associated with the general-purpose print software 202 and the printing apparatus 102. The general-purpose print software 202 is a standard driver provided by the provider of the OS. The standard driver is a class driver (general-purpose program) which can be commonly used for the printing apparatuses 102 of a plurality of makers, for example, when printing is performed. The standard driver is installed (incorporated) in the OS in advance, i.e. provided as one of functions in the OS package. The standard driver is capable of performing processing operations for a variety of printing apparatuses by using a standardized printing method. With this, the standard driver can generate and output an instruction which can be interpreted by the printing apparatuses of the plurality of makers. As the general-purpose print software 202, a program operating based on the Internet Printing Protocol (IPP) is used. The extension application 204 is a program supporting i.e. assisting the general-purpose print software 202. In the present embodiment, the extension application 204 is an extension program (application program for executing a control method) capable of extending functions which cannot be executed by the general-purpose print software 202, such that the functions can be extended, for the printing apparatus 102, but is not limited to this. For example, the extension application 204 can be a program which improves the convenience of functions which can be executed by the general-purpose print software 202 for the printing apparatus 102. The extension application 204 is stored in the external storage device 114 together with the OS including the general-purpose print software 202. With this, the host computer 101 has the general-purpose print software 202 and the extension application 204.

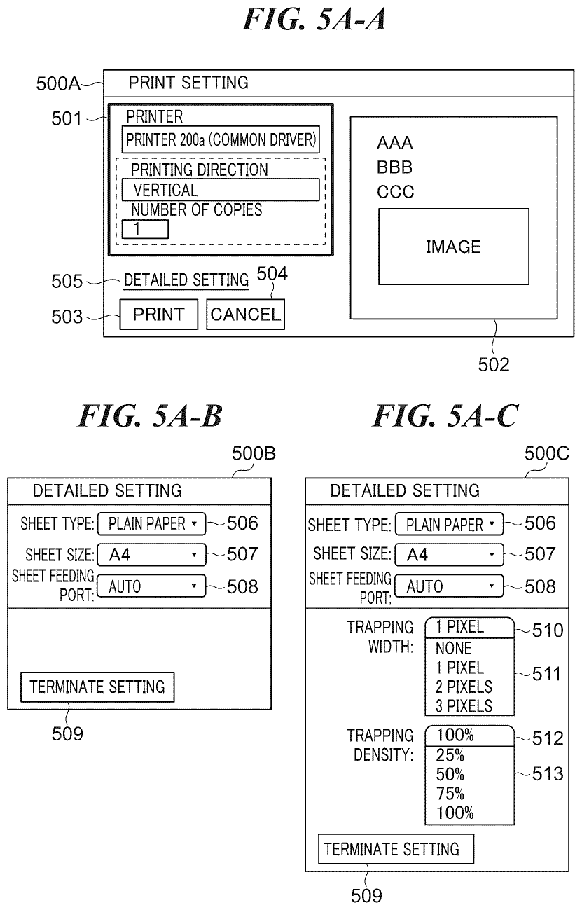

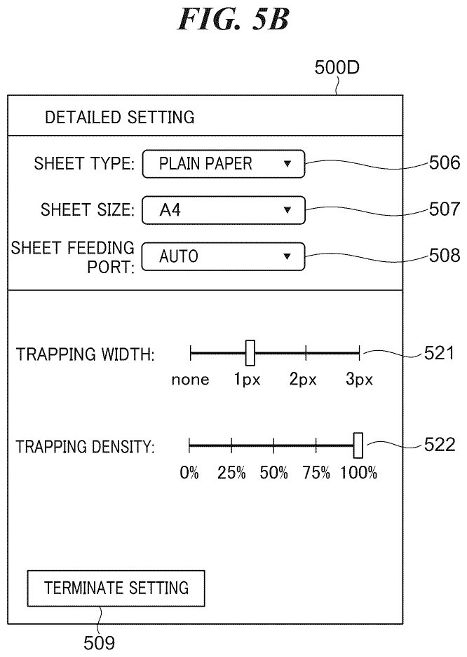

Referring to FIG. 2A-A, the configuration in the case where the extension application 204 is not associated with general-purpose print software 202 and the printing apparatus 102 will be described first. A drawing application 201 is software for generating contents (print data) to be printed by the printing apparatus 102. The drawing application 201 is not particularly limited, but, for example, a document generation application, a spreadsheet application or the like can be the drawing application 201. The drawing application 201 issues a print instruction to the OS e.g. upon receipt of a print request from a user via the keyboard 118. The print instruction includes print setting information for instructing operations of the general-purpose print software 202 and the printing apparatus 102. The print setting information is also referred to as the “Print Ticket (PT)”. Further, to output the print setting information, the drawing application 201 can display the print setting screen 500A (see FIG. 5A-A) provided by one of the general-purpose print software 202, the OS, and the drawing application 201, on the display section 119. Further, when a control 505 in the print setting screen 500A is operated (pressed), the drawing application 201 can display a detailed setting screen 500B (see FIG. 5A-B) or the detailed setting screen 500C (see FIG. 5A-C) on the display section 119. The print setting screen 500A to the detailed setting screen 500C will be described hereinafter. The print setting screen 500A includes a setting item indicating a print function which can be set according to capabilities information acquired by the general-purpose print software 202, i.e. information which can be set as the print setting, and a control item indicating its setting. The capabilities information refers to information related to the capabilities of the printing apparatus 102 for performing printing and is also referred to as the Print Capabilities (hereinafter sometimes referred to as the “PC”). Further, with this capabilities information, it is also possible to determine whether or not information which enables the display of the detailed setting screen 500C is included (determination step). Then, as a result of this determination, if it is determined that the information which enables the display of the detailed setting screen 500C is included, the detailed setting screen 500C can be caused to be displayed. On the other hand, if it is determined that the information which enables the display of the detailed setting screen 500C is not included, the display of the detailed setting screen 500C is inhibited. Thus, the extension application 204 can switch whether or not to display the detailed setting screen 500C according to the capabilities information of the printing apparatus 102.

The general-purpose print software 202 determines a PC based on print function information 203. The print function information 203 is data indicating all print functions which can be set, settings of these print functions, and a print function describing an exclusive relation between settings and the like. The print function information 203 is also referred to as the PDC. The print function information 203 is included in a configuration file of the general-purpose print software 202 and is arranged in the external storage device 114 as an unchangeable file. Alternatively, the print function information 203 is dynamically generated by the general-purpose print software 202. Specifically, the general-purpose print software 202 acquires attribute data of the printing apparatus 102 from the printing apparatus 102. The general-purpose print software 202 generates the print function information 203 according to attribute information in the attribute data. Note that in a case where the print function information 203 is dynamically generated as described above, the print function information 203 can be edited. Further, the attribute data of the printing apparatus 102 refers to a response acquired by issuing a “Get-Printer-Attributes” operation of the IPP to the printing apparatus 102. The response includes the attribute information indicating the functions which can be designated in the printing apparatus 102, i.e. capabilities of the printing apparatus 102 and settings associated with the attribute information. Further, the response is stored in the RAM 113.

With the configuration described above, the general-purpose print software 202 enables a user to designate a print function which can be used in the printing apparatus 102, according to the printing apparatus 102 connected to the general-purpose print software 202. With this, regardless of the printing apparatus 102 connected to the general-purpose print software 202, i.e. even in a case where the printing apparatus 102 having a different function or the printing apparatus 102 developed by a different printer maker is connected, it is possible to designate a print function which can be used in the connected printing apparatus 102. Note that in the present embodiment, it is assumed that the general-purpose print software 202 is configured to use the IPP Class Driver installed in Windows (registered trademark) 11. The IPP Class Driver is a printer driver that executes print processing according to specifications of a standard print protocol referred to as the IPP, and is incorporated in the OS package. The IPP Class Driver is not a printer driver specific to a model of the printing apparatus 102 but is a standard class driver which can be commonly used for printing apparatuses 102 of printer makers, without depending on a specific printer maker. Further, the IPP Class Driver acquires the capabilities information of the printing apparatus 102 and generates the print function information 203 based on the acquired information.

Further, the general-purpose print software 202 can be associated with the extension application 204. This enables the general-purpose print software 202 to execute a function which is not supported by the general-purpose print software 202. For example, the IPP Class Driver (the general-purpose print software 202) cannot execute a function of receiving a setting of trapping processing for image data. This is because the trapping processing setting function is a function uniquely executed by the printing apparatus 102 manufactured by a predetermined printer maker. The extension application 204 can extend the trapping processing setting function which cannot be executed by the IPP Class Driver such that the trapping processing setting function can be executed. Although in the present embodiment, the IPP Class Driver cannot execute the trapping processing setting function, and the extension application 204 can extend the trapping processing setting function such that the trapping processing setting function can be executed, this is not limitative. For example, the IPP Class Driver can execute part of the trapping processing setting function, and the extension application 204 can further extend the execution range by compensating for the shortage of the trapping processing setting function.

FIG. 2B is a flowchart of an imaging process performed by the printing apparatus. A program of the imaging process shown in FIG. 2B is stored in a ROM, not shown, of the printing apparatus 102. A CPU, not shown, of the printing apparatus 102 can load this program from the ROM of the printing apparatus 102 into a RAM, not shown, and execute the loaded program. Referring to FIG. 2B, in a step S2101, the printing apparatus 102 (CPU) generates bitmap image data by rasterizing print data received from the general-purpose print software 202 or the extension application 204. In the present embodiment, the general-purpose print software 202 or the extension application 204 processes data of the RGB format, and hence image data of the RGB color space is generated as the bitmap image data.

In a step S2102, the printing apparatus 102 performs color conversion processing for converting the image data of the RGB color space to image data of the CMYK color space. This color conversion processing is performed by using a lookup table (hereinafter referred to as the “LUT”) for outputting a four-dimensional value from a three-dimensional input value. Preferably, this color conversion processing is performed before the trapping processing. This is because the trapping processing is performed for the purpose of preventing a white blank space from being caused by shift of a color plate on a printed matter printed by the printing apparatus 102, and hence it is preferable that the trapping processing is finally performed in the color space on the printed matter.

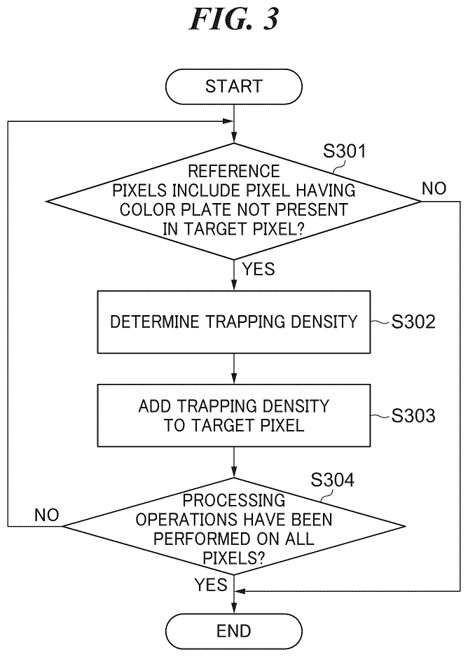

In a step S2103, the printing apparatus 102 performs a trapping process for executing the trapping processing on the image data of the CMYK color space. The trapping process will be described hereinafter with reference to FIG. 3.

In a step S2104, the printing apparatus 102 performs gamma correction processing on the image data on which the trapping processing has been performed. By performing the gamma correction processing, density characteristics of an image based on image data subjected to screen processing become desired characteristics when the image is transferred onto a recording sheet. Note that the gamma correction processing is performed using a one-dimensional LUT.

In a step S2105, the printing apparatus 102 performs the screen processing on the image data subjected to the gamma correction processing. By performing the screen processing, multivalued image data can be quantized to data which can be printed by a printing apparatus. In the present embodiment, as the screen processing, a dither method is used. The dither method is a processing method of converting data to 0 (toner is not output) and 1 (toner is output) by sequentially comparing a threshold value table of M×N threshold values arranged in a matrix having a width M and a height N, and pixel values of image data. The image data subjected to the screen processing is printed.

FIG. 3 is a flowchart of the trapping process (subroutine) in the step S2103 of the imaging process in FIG. 2B. Note that target pixels referred to hereinafter are pixels of which the colors (pixel values) are to be replaced. Reference pixels refer to pixels in an area (reference area) around the target pixels as the center (such as 8 pixels or 15 pixels in the vicinity of each target pixel). Further, the size of the reference area is changed according to a trapping width. For example, in a case where the trapping width is a width of N pixels, the reference area is an area of ((2N+1)×(2N+1)) pixels. As shown in FIG. 3, in a step S301, to determine whether or not a white blank space can be caused due to shift of a color plate, the printing apparatus 102 determines whether or not reference pixels include a pixel having a color plate not present in the target pixel. For example, in a reference area of 3×3 pixels, in a case where target pixels are formed by two colors of cyan and black, and the reference pixels are formed by only one color of magenta, it is determined in the step S301 that there is a pixel having a color plate not present in the target pixel. In this case, the process proceeds to a step S302. On the other hand, in a case where all reference pixels are formed by two colors of cyan and magenta, i.e. in a case where the target pixels and the reference pixels have the same color plate, a white blank space is not caused due to shift of a color plate, and hence it is determined in the step S301 that there is no pixel having a color plate not present in the target pixel. In this case, the process is terminated.

In the step S302, the printing apparatus 102 determines a trapping density based on the trapping density set by a user operation and a value of the pixel, which is determined in the step S301, of the color plate not present in the target pixel. For example, in a case where the color plate determined in the step S301 is magenta, its pixel value is 128 (8 bits), and at the same time the trapping density set by the user operation is 25%, the trapping density is determined as 32 (=128×0.25).

In a step S303, the printing apparatus 102 adds the trapping density determined in the step S302 to the target pixel.

In a step S304, the printing apparatus 102 determines whether or not the processing operations in the steps S301 to S304 have been performed on all pixels. If it is determined in the step S304 that the processing operations have been performed on all pixels, the present process is terminated. On the other hand, if it is determined in the step S304 that the processing operations have not been performed on all pixels, the process returns to the step S301, and the step S301 et seq. are sequentially executed. Note that in the present embodiment, any color plate can be added to a target pixel, but this is not limitative. For example, in a case where black is added to the target pixel, black is a color which is low in brightness, and hence there is a fear that a change in image quality becomes conspicuous. In view of this, processing for determining whether or not to add black to each target pixel can be added. Further, in a case where colors of target pixels and reference pixels are light, a white blank space caused due to shift of a color plate is less noticeable. In view of this, processing for determining whether or not target pixels and t reference pixels have a density not lower than a threshold value can be added.

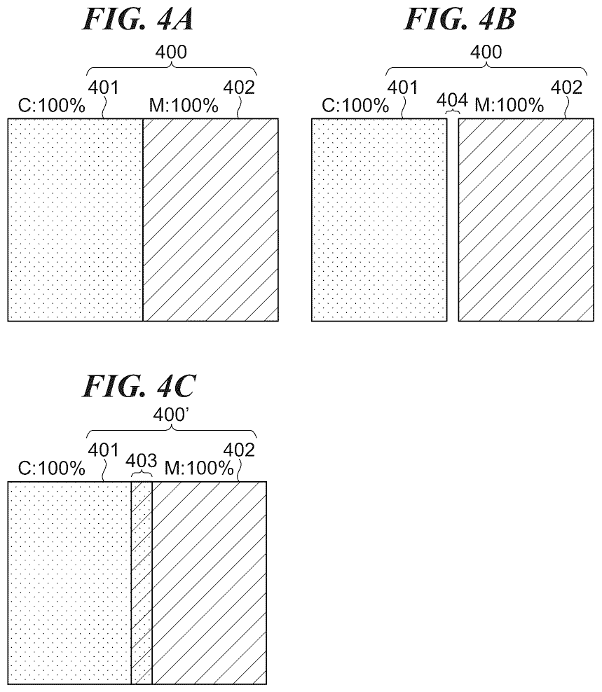

FIGS. 4A to 4C are diagrams useful in explaining an effect of the trapping processing. FIG. 4A is a diagram showing an image of image data before execution of the trapping processing. FIG. 4B is a diagram showing a state of an image in which a white blank space is caused. FIG. 4C is a diagram showing an image after execution of the trapping processing. As shown in FIG. 4A, the image, denoted by reference numeral 400, is formed by a first area 401 and a second area 402. The first area 401 is in cyan at 100%, and the second area 402 is in magenta at 100%. If no color plate shift occurs in the printing apparatus 102, the image 400 is printed in the state shown in FIG. 4A. On the other hand, in a case where the first area 401 shifts to the left side with respect to the second area 402 during printing, as shown in FIG. 4B, a white blank space 404 is caused between the first area 401 and the second area 402. The trapping processing is performed to prevent this white blank space 404. By performing the trapping processing, image data of an image 400′ shown in FIG. 4C is generated from the image data of the image 400 shown in FIG. 4A. In the image 400′, an overlapping area 403 in which the first area 401 and the second area 402 overlap each other is formed. With this, even when the first area 401 shifts to the left side with respect to the second area 402 during printing, an amount of the shift can be absorbed by the overlapping area 403, and therefore, it is possible to print the image 400′ on which the white blank space 404 is prevented. Note that by adjusting the trapping width and the trapping density, described hereinafter, it is possible to adjust the width and the density of the overlapping area 403. Further, although the overlapping area 403 is an area in which two colors overlap each other in the configuration shown in FIGS. 4A to 4C, this is not limitative, but, for example, the overlapping area 403 can be an area in which three or more colors overlap each other.

Here, the description refers again to FIG. 2A-A. The OS generates intermediate data (sometimes referred to as the input data) based on a print instruction output from the drawing application 201 and transmits the generated intermediate data to the general-purpose print software 202. The data to be output for printing from the drawing application 201 is not particularly limited, but, for example, data of the XML Paper Specification format (XPS format) is preferable. Further, as the data to be output for printing from the drawing application 201, data of the Graphic Device Interface format (GDI format) can be used. In a case where the IPP Class Driver is used as the general-purpose print software 202, if data output from the drawing application 201 is GDI data, the OS converts the GDI data to XPS data. Then, the OS transmits the converted XPS data to the general-purpose print software 202 as the intermediate data. Further, if data output from the drawing application 201 is XPS data, the OS transmits the XPS data to the general-purpose print software 202 as the intermediate data. Note that the intermediate data includes drawing data as information on characters, figures, and the like, which are to be formed on a printing medium, and the print setting information set by the user.

The general-purpose print software 202 converts the intermediate data to print data (image data) which can be processed, i.e. can be printed by the printing apparatus 102 and transmits the converted data to the printing apparatus 102. Here, the print data in the present embodiment is page description language (PDL) data conforming to the IPP. The PDL data is, for example, data of the portable document format (PDF) or of the PWG-Raster format. Note that the print data includes drawing data as information on e.g. characters, figures, and the like, which are to be formed on a print sheet (printing medium), and print setting attribute information designating print settings, which is generated based on the print setting information set by the user. The print setting attribute information includes attribute information indicating functions which can be designated in the printing apparatus 102, i.e. the capabilities of the printing apparatus 102, and settings associated with the attribute information.

The printing apparatus 102 performs printing on a print sheet based on the print data transmitted from the general-purpose print software 202. In doing this, the printing apparatus 102 can form an image on the print sheet based on the drawing data included in the print data, by performing operations according to the print setting attribute information included in the print data. Note that the print setting attribute information includes the attribute information for designating a print quality setting, such as image quality priority or speed priority, single-side printing or double-sided printing, and so forth, and settings of the attribute information. For example, in a case where attribute information designating double-sided printing is included in the print setting attribute information, the printing apparatus 102 can execute double-sided printing.

Referring to FIG. 2A-B, the configuration in the case where the extension application 204 is associated with the general-purpose print software 202 and the printing apparatus 102 will be described. As shown in FIG. 2A-B, differently from FIG. 2A-A, the extension application 204 is additionally provided. That is, the host computer 101 includes the drawing application 201, the general-purpose print software 202, and the print function information 203, and further has the extension application 204. The extension application 204 is software for extending the functions of the general-purpose print software 202. Note that the extension application 204 is software not included (packaged) in the OS in advance. Therefore, the extension application 204 is downloaded from a server (not shown) via the Internet and installed into the host computer 101 according to a user's operation of the host computer 101. Alternatively, when the printing apparatus 102 is connected to the host computer 101, the extension application 204 can be automatically installed into the host computer 101 according to this connection. Specifically, in a case where the printing apparatus 102 is connected to the host computer 101, the OS acquires device identification information from the printing apparatus 102. The OS can download the extension application 204 associated with this device identification information from the server via the Internet and install the downloaded extension application 204. As a result, in the host computer 101, the general-purpose print software 202 and the extension application 204 are held as control programs different from each other. Note that the general-purpose print software 202 and the extension application 204 are sometimes updated and their versions are upgraded, respectively. The processing for updating the general-purpose print software 202 and the processing for updating the extension application 204 in this case are performed at the same timing or at different timings. Further, a trigger with which the general-purpose print software 202 is acquired by the host computer 101 and a trigger with which the extension application 204 is acquired by the host computer 101 can be the same trigger or the different triggers. Further, in a case where the extension application 204 has been installed, the OS associates the extension application 204 with the general-purpose print software 202 and the printing apparatus 102.

As shown in FIG. 2A-B, the extension application 204 is capable of exchanging information (transmission and reception of information) with the general-purpose print software 202 and the printing apparatus 102, respectively. That is, the extension application 204 is associated with the general-purpose print software 202 and the printing apparatus 102. In the present embodiment, the extension application 204 includes a print setting screen-extending unit 205, a print function-extending unit 206, an intermediate data-editing unit 207, and a notification unit 209. Further, the extension application 204 includes shared information 208 which can be accessed from each of the print setting screen-extending unit 205, the print function-extending unit 206, the intermediate data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the whole operation of the extension application 204 in accordance with termination of processing executed by each unit of the print setting screen-extending unit 205 to the notification unit 209. In this case, the OS starts the extension application 204 whenever a request for causing each unit to execute processing is received. Further, the OS terminates the whole operation of the extension application 204 in a case where processing executed e.g. by the print setting screen-extending unit 205 is terminated. Further, while the processing is being performed by each unit of the print setting screen-extending unit 205 to the notification unit 209, the extension application 204 can cancel this processing. In this case, a job being processed on a print queue is deleted by the OS. As described above, upon receipt of a print request from a user, the drawing application 201 issues a print instruction to the OS. Further, the drawing application 201 can display the print setting screen. In the configuration shown in FIG. 2A-B, the drawing application 201 can display the print setting screen 500A (detailed setting screen 500C) provided by the print setting screen-extending unit 205 (the extension application 204). Further, the print setting screen-extending unit 205 can store detailed settings made by the user in the shared information 208. Details of the print setting screen-extending unit 205 will be described hereinafter.

The intermediate data-editing unit 207 acquires intermediate data from the general-purpose print software 202. Then, the intermediate data-editing unit 207 converts the intermediate data to print data and then transmits the print data to the printing apparatus 102. Further, the intermediate data-editing unit 207 acquires detailed setting information from the shared information 208 and adds the detailed settings to the print data. The printing apparatus 102 performs printing on a sheet surface based on the print data received from the intermediate data-editing unit 207. Note that the extension application 204 can be configured to acquire print data generated by the general-purpose print software 202 and add the detailed settings to the print data. Further, also in the case of the configuration shown in FIG. 2A-B, there is a case where the trapping setting is not executed. In this case, the general-purpose print software 202 can transmit print data to the printing apparatus 102 without using the extension application 204.

The print function-extending unit 206 can edit the print function information 203 (PDC) generated by the general-purpose print software 202 or the OS. This makes it possible to add a function provided by the extension application 204. Further, it is also possible to add a function which can be executed in the printing apparatus 102 but cannot be executed by the general-purpose print software 202 (such as the trapping function) and add an exclusive relationship between settings of the print function. The OS starts the print function-extending unit 206 when the extension application 204 is associated with the printing apparatus 102 and the general-purpose print software 202 for the first time. Further, the OS can start the print function-extending unit 206 at a timing other than this (e.g. at a timing when the OS is started). By starting the print function-extending unit 206 as described above, even in a case where a function related to printing is extended later, the print function-extending unit 206 can detect the extended function and add the detected function to the print function information 203. Examples of the case where the function related to printing is extended later include a case where an optional apparatus (such as a finisher) is added to the printing apparatus 102 afterwards.

The notification unit 209 can provide, when an error of the printing apparatus 102 occurs, a notification indicating this fact. For example, if a paper-out error has occurred in the printing apparatus 102, the general-purpose print software 202 detects occurrence of this error. The OS displays a message showing occurrence of the paper-out error as a result of the detection performed by the general-purpose print software 202 on the display section 119 by using a notification function called a toast notification which is one of the functions of the OS. Note that when the user operates the toast notification, the notification unit 209 is called by the OS, and a user interface screen (UI screen) of the notification unit 209 is displayed. On the user interface screen, for example, a detailed message concerning the paper-out error, a paper filling method, and so forth can be displayed.

As described above, in the present embodiment, it can be said that the extension application 204 has the following four functions: The first function is the function of displaying a setting screen. This function is executed by the print setting screen-extending unit 205. The second function is the function of editing intermediate data, converting the intermediate data to print data, and adding detailed settings to the print data. This function is executed by the intermediate data-editing unit 207. The third function is the function of extending a function which can be designated by using print data generation software. This function is executed by the print function-extending unit 206. The fourth function is the function of displaying a screen in response to occurrence of an error in the printing apparatus 102. This function is executed by the notification unit 209. Note that the configuration of the extension application 204 is not limited to the configuration having these four functions but preferably includes at least one function of them, and further, the extension application 204 can be configured to further have another function. Further, when print data is once transmitted to the printing apparatus 102, the extension application 204 cannot display a screen, such as a guide associated with the print data, during execution of processing performed by each unit.

FIGS. 5A-A to 5A-C are diagrams each showing an example of a screen displayed on the display section of the printing system 1000. FIG. 5A-A shows the print setting screen displayed by the drawing application 201. FIG. 5A-B shows the detailed setting screen displayed in the case of the configuration in which the extension application 204 is not associated. FIG. 5A-C shows the detailed setting screen displayed in the case of the configuration in which the extension application 204 is associated. Note that a unit or module that displays each screen is not particularly limited. For example, the print setting screen-extending unit 205 can be configured to generate only a display screen. In this case, the print setting screen-extending unit 205 transmits the generated display screen to the drawing application 201 via the general-purpose print software 202. The drawing application 201 can be configured to display the acquired display screen.

The print setting screen 500A shown in FIG. 5A-A is a screen on which print conditions associated with printing performed by the printing apparatus 102 can be set. This print setting screen 500A includes a control (button) 501, a control 502, a control 503, a control 504, and the control 505. With the control 501, the user can set the printing apparatus 102 used for printing, a direction of printing performed by the printing apparatus 102, and the number of copies to be printed by the printing apparatus 102. In the illustrated example in FIG. 5A-A, the printing apparatus 102 used for printing is set to “printer 200a”, the direction of printing performed by the printing apparatus 102 is set to “vertical”, and the number of copies to be printed by the printing apparatus 102 is set to “1” by way of example. Under the control 502, a preview screen is displayed. With the control 503, the user can instruct the printing apparatus 102 to start printing. With the control 504, the user can instruct the printing apparatus 102 to cancel printing. With the control 505, the user can make detailed settings.

When the control 505 is operated in the case of the configuration in which the extension application 204 is not associated, the detailed setting screen 500B shown in FIG. 5A-B is displayed. The detailed setting screen 500B includes a control 506, a control 507, a control 508, and a control 509. The controls 506 to 508 are arranged vertically in an upper part of the detailed setting screen 500B. The control 509 is arranged in a lower part of the detailed setting screen 500B. With the control 506, the user can select and set a sheet type to be used for printing performed by the printing apparatus 102. In the illustrated example in FIG. 5A-B, “plain paper” is selected by way of example. With the control 507, the user can select and set a sheet size to be used for printing performed by the printing apparatus 102. In the illustrated example in FIG. 5A-B, “A4” is selected by way of example. With the control 508, the user can select a sheet feeding port to be used for printing performed by the printing apparatus 102. In the illustrated example in FIG. 5A-B, “auto” is selected by way of example. With the control 509, the user can terminate making settings with the controls 506 to 508. Further, when the control 509 is operated, the screen returns to the print setting screen 500A shown in FIG. 5A-A.

When the control 505 is operated in the case of the configuration in which the extension application 204 is associated, the detailed setting screen (setting reception screen) 500C shown in FIG. 5A-C is displayed (display control step). Note that the detailed setting screen 500C is a screen displayed together with the print setting screen 500A, but its display form is not particularly limited. For example, the detailed setting screen 500C can be displayed in a state overlapping the print setting screen 500A, or can be displayed adjacent to the print setting screen 500A, or can be displayed after the print setting screen 500A once disappears. The detailed setting screen 500C is a screen which can receive settings of the trapping processing (hereinafter referred to as the “trapping settings”) for image data. Similar to the detailed setting screen 500B, the detailed setting screen 500C includes the controls 506 to 509. Further, the detailed setting screen 500C additionally includes controls 510 and 512 as trapping settings.

The control 510 is a width setting section for setting a width (trapping width) of the overlapping area 403 (see FIG. 4C) in which the first area 401 and the second area 402 overlap each other. When the control 510 is operated, a list 511 including “none”, “1 pixel”, “2 pixels”, and “3 pixels” is displayed. Then, the user can select a desired option from “none”, “1 pixel”, “2 pixels”, and “3 pixels”. In a case where “none” is selected, the trapping setting can be omitted. In a case where “1 pixel” is selected, the width of the overlapping area 403 can be set to a width corresponding to 1 pixel. In a case where “2 pixels” is selected, the width of the overlapping area 403 can be set to a width corresponding to 2 pixels. In a case where “3 pixels” is selected, the width of the overlapping area 403 can be set to a width corresponding to 3 pixels. Note that FIG. 5A-C shows a state in which “1 pixel” is selected by way of example. Further, the width of the overlapping area 403, included in the list 511, is not limited to three types, but, for example, two types or four or more types can be included.

The control 512 is a density setting section for setting the density (trapping density), i.e., the transmittance in the overlapping area 403. This density is a trapping density to be added to the target pixel. When the control 512 is operated, a list 513 including “25%”, “50%”, “75%”, and “100%” is displayed. Then, the user can select a desired option from “25%”, “50%”, “75%”, and “100%”. In a case where “25%” is selected, the density of the overlapping area 403 can be set to 25%. In a case where “50%” is selected, the density of the overlapping area 403 can be set to 50%. In a case where “75%” is selected, the density of the overlapping area 403 can be set to 75%. In a case where “100%” is selected, the density of the overlapping area 403 can be set to 100%. Note that FIG. 5A-C shows a state in which “100%” is selected by way of example. Further, the density of the overlapping area 403, included in the list 513, is not limited to four types, but, for example, two types, three types, or five or more types can be included.

Then, the user can cause the printing apparatus 102 to execute the trapping processing with the settings received according to the above-mentioned operations of the control 510 and the control 512. Note that although the detailed setting screen 500C includes both of the control 510 and the control 512 in the present embodiment, this is not limitative, but, for example, at least one of the control 510 and the control 512 can be included.

FIG. 5B is a diagram showing a variation of the screen displayed on the display section of the printing system 1000. As shown in FIG. 5B, similar to the detailed setting screen 500C, a detailed setting screen 500D includes the control 506 to the control 509. Further, the detailed setting screen 500D additionally includes a slide bar 521 and a slide bar 522 for making trapping settings. The slide bar 521 is a width setting section for setting a width of the overlapping area 403. When the control 521 is operated, the user can select a desired option from “none”, “1 pixel”, “2 pixels”, and “3 pixels”. FIG. 5B shows a state in which “1 pixel” is selected by way of example. The slide bar 522 is a density setting section for setting the density in the overlapping area 403. When the slide bar 522 is operated, the user can select a desired density from a range of “0%” to “100%”. Thus, with the slide bar 522, it is possible to not only select a density, such as “25%” and “50%”, but also select a density between “25%” and “50%”. With this, it is possible to finely set the density. Note that FIG. 5B shows a state in which “100%” is selected by way of example.

Here, a reason why the items included in the detailed setting screen 500B shown in FIG. 5A-B and the items included in the detailed setting screen 500C shown in FIG. 5A-C are different will be described. The detailed setting screen 500B and the detailed setting screen 500C are generated based on respective pieces of the print function information (capabilities information). As described hereinabove, the general-purpose print software 202 does not support execution of the trapping function. Therefore, the trapping function cannot be added to the print function information only by the general-purpose print software 202. Further, even if the trapping function is originally included in the print function information, the general-purpose print software 202 cannot interpret the trapping function included in the print function information. For this reason, the trapping function settings cannot be displayed on the detailed setting screen. To cope with this, the print function-extending unit 206 adds the trapping function to the print function information 203. Then, the print setting screen-extending unit 205 displays the detailed setting screen 500C by referring to the capabilities information. With this, the extension application 204 can display sections for making settings of the trapping function on the detailed setting screen.

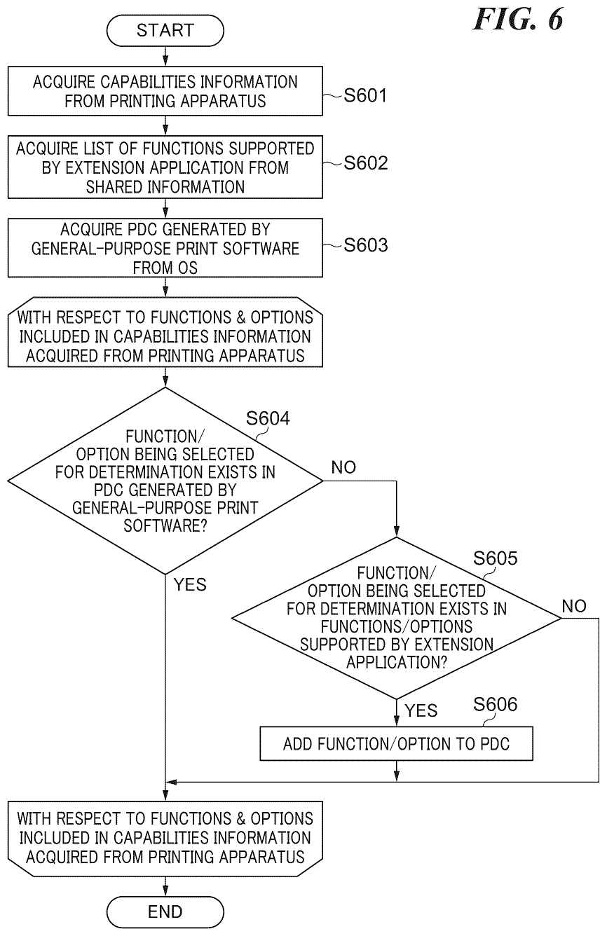

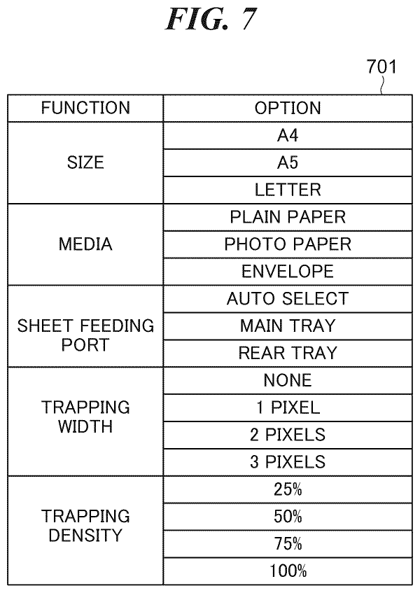

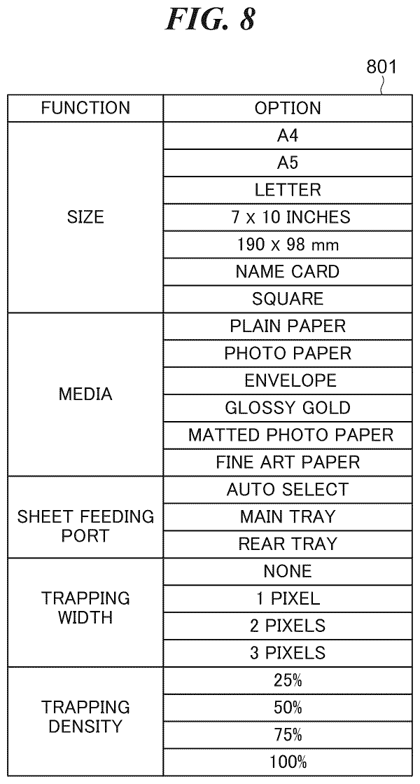

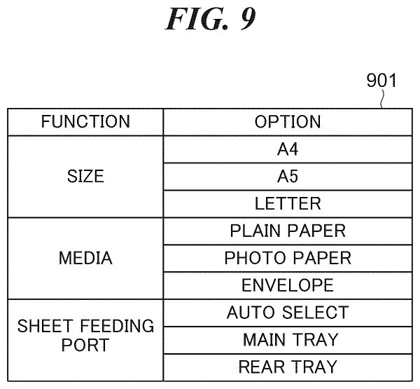

FIG. 6 is a flowchart of a process performed by the print function-extending unit 206, for editing the print function information. Note that a program of the process in FIG. 6 is executed by the print function-extending unit 206 under the control of the CPU 111. FIG. 7 is a diagram showing an example of a list of the capabilities information of the printing apparatus 102. FIG. 8 is a diagram showing an example of a list of the print functions supported by the extension application. FIG. 9 is a diagram showing an example of a list of the capabilities information of the general-purpose print software. Referring to FIG. 6, in a step S601, the print function-extending unit 206 acquires the capabilities information from the printing apparatus 102 before the above-described display control step (acquisition step). The capabilities information is information related to capabilities of the printing apparatus 102, for performing printing, and in the present embodiment, the capabilities information is settings included in a response acquired by issuing a “Get-Printer-Attributes” operation of the IPP to the printing apparatus 102. The settings are attribute information indicating the functions which can be designated in the printing apparatus 102 and settings associated with this attribute information. A table 701 shown in FIG. 7 indicates a list of the capabilities information of the printing apparatus 102. For example, the capabilities information includes information related to sizes of sheets to be used for printing performed by the printing apparatus 102. Further, the capabilities information includes information related to types of sheets (media) to be used for printing performed by the printing apparatus 102, information related to sheet feeding ports to be used for printing performed by the printing apparatus 102, and information related to the trapping function which can be executed by the printing apparatus 102. The trapping function includes a trapping width-setting function for setting a trapping width and a trapping density-setting function for setting a trapping density.

In a step S602, the print function-extending unit 206 acquires print functions supported by the extension application 204 from the shared information 208. In the shared information 208, a list of the print functions supported by the extension application 204 is stored. This list includes all print functions which can be processed by the extension application 204 and settings of these print functions. A table 801 shown in FIG. 8 includes, as information related to the print function, sheet sizes supported by the extension application 204. The table 807 further includes information related to sheet types supported by the extension application 204, information related to sheet feeding ports supported by the extension application 204, and information related to the trapping function supported by the extension application 204. Further, the print functions supported by the extension application 204 are sometimes updated e.g. by the update of the extension application 204.

In a step S603, the print function-extending unit 206 acquires the print function information 203 (PDC) generated by the general-purpose print software 202 from the OS. The print function information 203 is generated by the general-purpose print software 202 based on the capabilities information (see the table 701) acquired from the printing apparatus 102. The print function information 203 (PDC) generated by the general-purpose print software 202 includes only the print functions supported by the general-purpose print software 202, out of the capabilities information acquired from the printing apparatus 102. For example, the table 801 shown in FIG. 8 includes “7×10 inches” and “190×98 mm” as the sheet sizes, but in a table 901 shown in FIG. 9, the general-purpose print software 202 does not support these sheet sizes, and hence these sheet sizes are not included in the print function information 203. Further, the table 801 shown in FIG. 8 includes the information related to the trapping function, but in the table 901 shown in FIG. 9, the general-purpose print software 202 does not support the trapping function, and hence the trapping function is not included in the print function information 203. By adding a function and options to the print function information 203 by using the print function-extending unit 206, the extension application 204 can compensate for lack of the functions of the general-purpose print software 202. Further, the print function-extending unit 206 is also capable of deleting an unnecessary function and options thereof from the print function information 203 generated by the general-purpose print software 202.

Steps S604, S605, and S606 are processing operations which are repeatedly executed on the list of the functions included in the capabilities information acquired from the printing apparatus 102 in the step S601. In the present embodiment, the steps S604, S605, and S606 are repeatedly executed on all of the 10 options included in the table 901.

In the step S604, the print function-extending unit 206 determines whether or not an option of a function, being currently selected for determination, exists in the print function information 203 generated by the general-purpose print software 202. If it is determined in the step S604 that the option of the function, being currently selected for determination, exists in the print function information 203, the present process is terminated if the option being selected for determination is the final item of the options of all the functions. Alternatively, if the option being selected for determination is not the final item of the options of all the functions, the next item of the options of the function or an option of the next function is selected, and the step S604 is executed again. On the other hand, if it is determined in the step S604 that the option of the function, being currently selected for determination, does not exist in the print function information 203, the process proceeds to the step S605. For example, in the present embodiment, the sheet size “A4” is included in the table 701, and the sheet size “A4” is also included in the table 901. In this case, it is determined in the step S604 that the option of the function, being currently selected for determination, exists in the print function information 203. On the other hand, “the trapping function” is included in the table 701 but is not included in the table 901. In this case, it is determined in the step S604 that the option of the function, being currently selected for determination, does not exist in the print function information 203.

In the step S605, the print function-extending unit 206 determines whether or not the option of the function, being currently selected for determination, exists in the options of the functions supported by the extension application 204. If it is determined in the step S605 that the option of the function being currently selected for determination exists, the process proceeds to the step S606. On the other hand, if it is determined in the step S605 that the option of the function being currently selected for determination does not exist, similar to the case where the answer to the question of the step S604 is affirmative (YES), the present process is terminated if the option being selected for determination is the final item of the options of all the functions. Alternatively, if the option being selected for determination is not the final item of the options of all the functions, the next item of the options of the function or an option of the next function is selected, and the step S604 is executed again. For example, in the present embodiment, in a case where the option of the function being currently selected for determination is related to “the trapping function”, the option related to “the trapping function” also exists in the table 801. Therefore, it is determined in the step S605 that the option of the function being currently selected for determination exists.

In the step S606, the print function-extending unit 206 adds the function and its option being currently selected for determination to the print function information 203 (PDC). After execution of the step S606, similar to the case where the answer to the question of the step S604 is affirmative (YES), the present process is terminated if the option being selected for determination is the final item of the options of all the functions. Alternatively, if the option being selected for determination is not the final item of the options of all the functions, the next item of the options of the function or an option of the next function is selected, and the step S604 is executed again.

As described above, the extension application 204 can add, to the print function information 203, a function (and its options) which are not supported by the general-purpose print software 202 but are supported by the printing apparatus 102, and at the same time can be supported by the extension application 204. Then, the capabilities information (PC) is generated based on the print function information 203 edited by this addition processing. Further, by generating a display screen based on the resulting capabilities information, the print setting screen-extending unit 205 can extend the function not supported by the general-purpose print software 202 and display the detailed setting screen 500C.

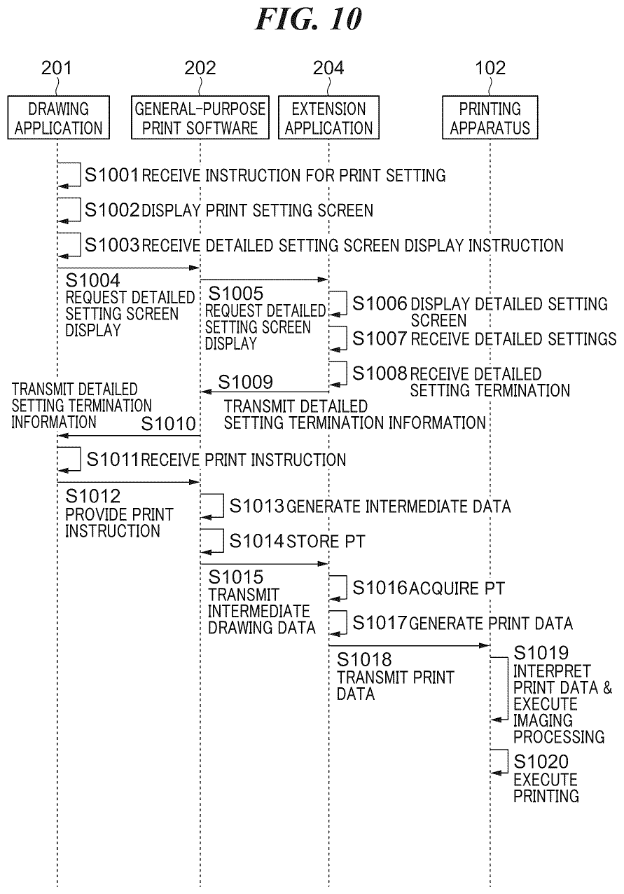

FIG. 10 is a sequence diagram showing a process executed between the drawing application 201, the general-purpose print software 202, the extension application 204, and the printing apparatus 102, after the drawing application 201 receives the print settings. Processing operations by the drawing application 201, the general-purpose print software 202, and the extension application 204 are executed by the CPU 111 of the host computer 101. A program for the processing operations is stored in the external storage device 114. The CPU 111 loads the program from the external storage device 114 into the RAM 113 and executes the loaded program. Further, processing operations performed by the printing apparatus 102 are executed by the CPU (not shown) of the printing apparatus 102. Further, the software configuration of the printing system 1000 is the software configuration shown in FIG. 2A-B.

Referring to FIG. 10, in a step S1001, the drawing application 201 receives an instruction provided by the user for print setting. The user can instruct providing the print settings to the drawing application 201 by operating e.g. the pointing device 117 and the keyboard 118.

In a step S1002, the drawing application 201 displays the print setting screen 500A shown in FIG. 5A-A on the display section 119.

In a step S1003, the drawing application 201 receives an instruction provided by the user for displaying a detailed setting screen. The user can instruct display of the detailed setting screen by operating e.g. the pointing device 117 and the keyboard 118 to select the control 505 on the print setting screen 500A.

In a step S1004, the drawing application 201 requests the general-purpose print software 202 to display the detailed setting screen.

In a step S1005, the general-purpose print software 202 requests the extension application 204 to display the detailed setting screen.

In a step S1006, the print setting screen-extending unit 205 of the extension application 204 displays the detailed setting screen 500C shown in FIG. 5A-C. As described hereinabove, the trapping setting is added to the print function information 203 (PDC) by the print function-extending unit 206. The print setting screen-extending unit 205 can display the detailed setting screen 500C by referring to the capabilities information (PC) generated based on the print function information 203 to which the trapping setting has been added.

In a step S1007, the print setting screen-extending unit 205 receives detailed settings input by the user on the detailed setting screen 500C. Note that, here, on the detailed setting screen 500C, the sheet type “plain paper” is selected by the control 506, the sheet size “A4” is selected by the control 507, and the sheet feeding port “auto” is selected by the control 508 by way of example (see FIG. 5A-C). Further, “1 pixel” is selected by the control 510, and “100%” is selected by the control 512 (see FIG. 5A-C). In this setting state (selected state), the print setting screen-extending unit 205 receives the operation of the control 509, performed by the user, on the detailed setting screen 500C.

In a step S1008, the print setting screen-extending unit 205 receives termination of the detailed setting operation performed by the user based on the operation of the control 509 in the step S1007. The user can instruct termination of the detailed setting operation by selecting the control 509 through operating e.g. the pointing device 117 and the keyboard 118.

In a step S1009, the extension application 204 transmits detailed setting termination information to the effect that the detailed setting operation in the S1008 has been terminated, to the general-purpose print software 202.

In a step S1010, the general-purpose print software 202 receives the detailed setting termination information sent from the extension application 204 in the step S1009. Then, the general-purpose print software 202 transmits this detailed setting termination information to the drawing application 201.

In a step S1011, the drawing application 201 receives a print instruction provided by the user. The user can instruct printing by operating e.g. the pointing device 117 and the keyboard 118 to select the control 503 on the print setting screen 500A (see FIG. 5A-A).

In a step S1012, the drawing application 201 provides the print instruction received in the step S1011 to the general-purpose print software 202.

In a step S1013, the general-purpose print software 202 generates intermediate data based on the print instruction received in the step S1012 by using a module of the OS.

In a step S1014, the general-purpose print software 202 stores the print setting information (PT) based on the print instruction received in the step S1012 in the shared information 208.

In a step S1015, the general-purpose print software 202 transmits drawing data (image data) out of the intermediate data generated in the step S1013 to the extension application 204.

In a step S1016, the intermediate data-editing unit 207 of the extension application 204 acquires the print setting information (PT) stored in the step S1014 from the shared information 208.

In a step S1017, the intermediate data-editing unit 207 of the extension application 204 generates print data using the drawing data transmitted in the step S1015 and the print setting information acquired in the step S1016. This print data is data including a value (value information) of the trapping settings received on the detailed setting screen 500C.

In a step S1018, the intermediate data-editing unit 207 of the extension application 204 transmits the print data generated in the step S1017 to the printing apparatus 102 (transmission step). As described hereinabove, the print data includes the value information of the trapping settings received on the detailed setting screen 500C. Further, with this transmission, it is possible to instruct the printing apparatus 102 to execute the trapping processing based on the trapping settings (instruction step).

In a step S1019, the printing apparatus 102 receives the print data transmitted in the step S1018. The printing apparatus 102 interprets the print data and performs necessary imaging processing on the print data. As the imaging processing performed here, the trapping processing on the print data is performed based on the value information transmitted in the step S1018. With this, for example, in a case where the data of the image 400 shown in FIG. 4A is input data, the data of the image 400′ shown in FIG. 4C is generated.

In a step S1020, the printing apparatus 102 prints the print data on which the imaging processing has been performed in the step S1019. With this, the printed matter becomes a printed matter of the print data on which the trapping processing has been performed.

As described above, in the printing system 1000, even in a case where the general-purpose print software 202 does not support the trapping setting, the extension application 204 can display the detailed setting screen 500C shown in FIG. 5A-C. With the detailed setting screen 500C, it is possible to cause the printing apparatus 102 to execute the trapping processing. As a result, a printed matter of print data on which the trapping processing has been performed is printed from the printing apparatus 102. Note that in the description given with reference to FIG. 10, assuming that the software configuration of the printing system 1000 is the software configuration shown in FIG. 2A-B, the detailed setting screen 500C shown in FIG. 5A-C is displayed, but this is not limitative. For example, in a case where the display of the detailed setting screen is requested to the general-purpose print software 202 in the step S1004, the general-purpose print software 202 displays the detailed setting screen 500B shown in FIG. 5A-B. In this case, after the control 509 on the detailed setting screen 500B is operated, the general-purpose print software 202 requests the extension application 204 to display an additional detailed setting screen. Then, the extension application 204 can additionally display a detailed setting screen on which the trapping setting can be set. Further, although the extension application 204 generates print data from the intermediate data generated by the general-purpose print software 202 in the present embodiment, this is not limitative, but, for example, the extension application 204 itself can generate intermediate data.

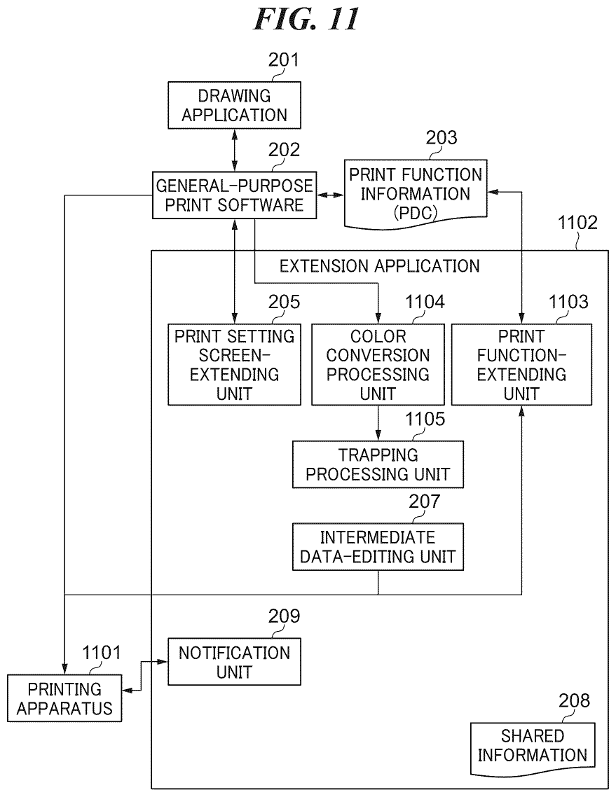

A second embodiment will be described below with reference to FIGS. 11 to 14, but the description will be given mainly of different points from the above-described first embodiment, and description of the same points is omitted. In the first embodiment, the extension application 204 generates print data including the trapping settings in cooperation with the general-purpose print software 202. This print data is transmitted to the printing apparatus 102. The printing apparatus 102 can interpret the print data including the trapping settings and execute the trapping processing. As described above, in the first embodiment, the extension application 204 causes the printing apparatus 102 to execute the trapping processing in cooperation with the general-purpose print software 202.

However, depending on the printing apparatus 102, there is a printing apparatus incapable of executing the trapping processing. In this case, even when the extension application 204 generates print data including the trapping settings, it is impossible to cause the printing apparatus 102 to execute the trapping processing. In a case where printing apparatus 102 cannot execute the trapping processing, it is preferable that the extension application 204 generates print data on which the trapping processing has been performed and transmits the print data thus generated to the printing apparatus 102.

Therefore, in the present embodiment, whether or not the trapping processing can be executed by the printing apparatus 102 is determined based on the capabilities information of the printing apparatus 102. As a result of this determination, if it is determined that the trapping processing can be executed by the printing apparatus 102, the extension application 204 generates print data including the trapping settings and transmits the print data to the printing apparatus 102. On the other hand, if it is determined that the trapping processing cannot be executed by the printing apparatus 102, the extension application 204 generates print data including drawing data on which the trapping processing has been executed and transmits the print data to the printing apparatus 102. This makes it possible, even in a case where the trapping processing cannot be executed by the printing apparatus 102, to provide the trapping processing to the user. Note that the present embodiment is the same as the first embodiment except differences in the configuration of the printing system 1000 in the case where the extension application 204 is associated, the PDC editing process, and the process after the drawing application 201 receives the print setting.

FIG. 11 is a block diagram showing a software configuration of the printing system 1000 according to the second embodiment. The block diagram shown in FIG. 11 is a diagram showing a configuration in a case where an extension application 1102 is associated with the general-purpose print software 202 and a printing apparatus 1101. As shown in FIG. 11, the host computer 101 includes the drawing application 201, the general-purpose print software 202, the print function information 203 (PDC), and the extension application 1102. Further, the extension application 1102 is communicably connected to the printing apparatus 1101. Different from the printing apparatus 102 in the first embodiment, the printing apparatus 1101 is a printing apparatus incapable of executing the trapping processing. The extension application 1102 includes the print setting screen-extending unit 205, the intermediate data-editing unit 207, the shared information 208, the notification unit 209, a print function-extending unit 1103, a color conversion processing unit 1104, and a trapping processing unit 1105. The print function-extending unit 1103 can add a trapping processing function to the print function information 203 even in a case where it is determined, based on the capabilities information acquired from the printing apparatus 1101, that the trapping processing cannot be executed by the printing apparatus 1101. The color conversion processing unit 1104 performs color conversion processing on intermediate data (drawing data) received from the general-purpose print software 202. The trapping processing unit 1105 performs the trapping processing on the intermediate data subjected to the color conversion processing, which is received from the color conversion processing unit 1104.

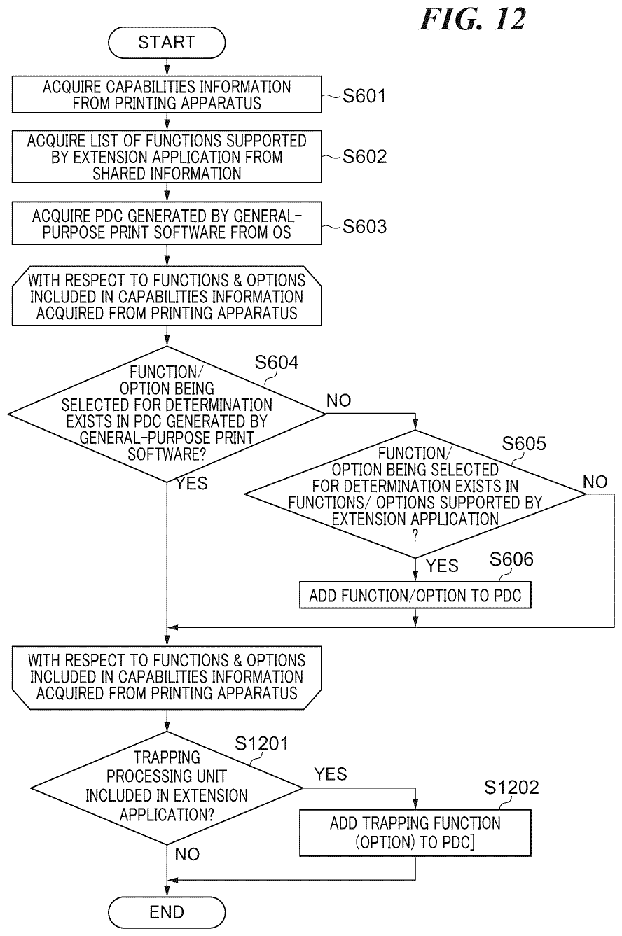

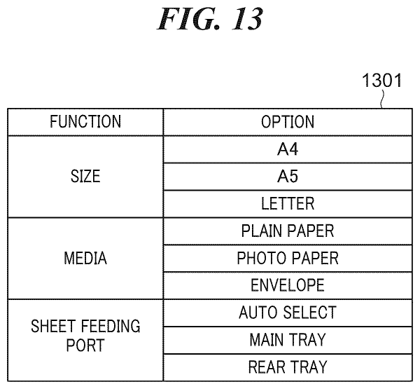

FIG. 12 is a flowchart of a process performed by the print function-extending unit for editing the print function information. Note that a program of the process in FIG. 12 is executed by the print function-extending unit 1103 under the control of the CPU 111. Further, in the process in FIG. 12, steps S1201 and S1202 are added to the process in FIG. 6. FIG. 13 is a diagram showing an example of a list of the capabilities information of the printing apparatus. Referring to FIG. 12, in a case where repetition of the steps S604 to S606 is terminated, the process proceeds to the step S1201. A table 1301 shown in FIG. 13 shows a list of the capabilities information of the printing apparatus 1101. This table 1301 includes, as capabilities information, the information related to sheet sizes, the information related to sheet types, and the information related to sheet feeding ports, but is different from the table 701 shown in FIG. 7 in that the information related to the trapping processing is not included. Therefore, it is understood that the printing apparatus 1101 is not capable of executing the trapping processing. For this reason, the trapping processing is not added to the print function information 203 after the processing operations in the steps S604 to S606 are terminated.

As shown in FIG. 12, in the step S1201, the print function-extending unit 1103 determines whether or not the trapping processing unit 1105 is included in the extension application 1102, i.e. presence/absence of the trapping processing unit 1105. If it is determined in the step S1201 that the trapping processing unit 1105 is included, the process proceeds to the step S1202. On the other hand, if it is determined in the step S1201 that the trapping processing unit 1105 is not included, the process is terminated. As described above, the extension application 1102 includes the trapping processing unit 1105, and hence the process proceeds to the step S1202.

In the step S1202, the print function-extending unit 1103 adds the trapping settings in the table 801 shown in FIG. 8, i.e. the information related to the trapping processing to the print function information 203.

As described above, the extension application 1102 can add a function (and its options) not supported by the general-purpose print software 202 and not supported by the printing apparatus 1101 but at the same time supported by the extension application 204, to the print function information 203. Then, the extension application 1102 determines presence/absence of the trapping processing unit 1105. As a result of this determination, if it is determined that the trapping processing unit 1105 is included, the trapping processing is added to the print function information 203. With this addition processing, even in a case where the trapping processing cannot be executed by the printing apparatus 1101, the capabilities information is generated based on the print function information 203 to which the trapping processing has been added. The extension application 1102 can display the detailed setting screen 500C shown in FIG. 5A-C by generating a display screen based on the capabilities information.

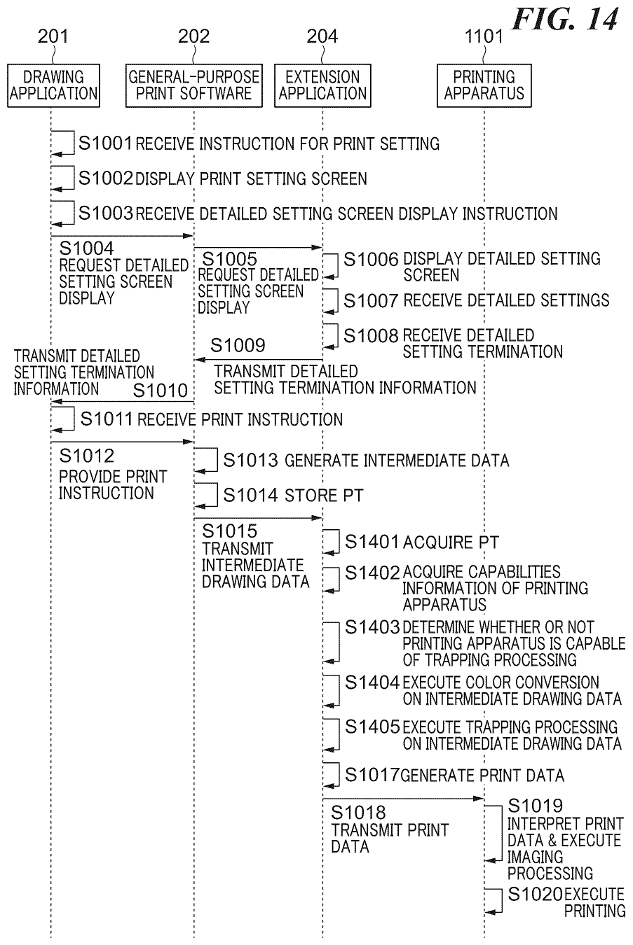

FIG. 14 is a sequence diagram showing a process executed between the drawing application 201, the general-purpose print software 202, the extension application 1102, and the printing apparatus 1101, after the drawing application 201 receives print settings. The sequence diagram shown in FIG. 14 is a sequence diagram mainly configured by adding steps S1401 to S1405 to the sequence diagram shown in FIG. 10. Referring to FIG. 14, after execution of the step S1015, the process proceeds to the step S1401. In the step S1401, the trapping processing unit 1105 of the extension application 1102 acquires the print setting information (PT) stored in the step S1014 from the shared information 208. Further, the trapping processing unit 1105 acquires the information related to the trapping processing, which is included in the print setting information. Note that in a case where the trapping width is set to “none”, the trapping processing is not executed, and hence the process skips the steps S1402 to S1405.

In the step S1402, the trapping processing unit 1105 acquires the capabilities information of the printing apparatus 1101 from the shared information 208. Note that in a case where the capabilities information of the printing apparatus 1101 is not included in the shared information 208, the print function-extending unit 1103 can request the capabilities information to the printing apparatus 1101. In this case as well, the capabilities information is stored in the shared information 208.

In the step S1403, the trapping processing unit 1105 determines, based on the capabilities information acquired in the step S1402, whether or not the trapping processing can be executed by the printing apparatus 1101. As described above, in the present embodiment, the printing apparatus 1101 is incapable of executing the trapping processing. Therefore, it is determined in the step S1403 that the trapping processing cannot be executed by the printing apparatus 1101. Note that if it is determined in the step S1403 that the trapping processing can be executed by the printing apparatus 1101, the process skips the steps S1404 and S1405 and proceeds to the step S1017. This is because, in general, the printing apparatus 1101 can perform the trapping processing at higher speed than the trapping processing unit 1105. Specifically, the printing apparatus 1101 can perform the trapping processing at higher speed than the trapping processing unit 1105 by using an application specific integrated Circuit (ASIC).

In the step S1404, the color conversion unit 1104 of the extension application 1102 performs color conversion processing for converting the intermediate drawing data to a color plate (CMYK data) which can be printed by the printing apparatus 1101. The intermediate drawing data subjected to the color conversion processing is stored in the shared information 208. Note that as a result of the determination in the step S1403, in a case where the processing operations in the steps S1404 and S1405 are omitted, the extension application 1102 generates print data of the RGB format in the step S1017 and transmits the generated print data to the printing apparatus 1101. In a case where the print data of the CMYK format is received, the printing apparatus 1101 omits the color conversion processing. Further, in a case where the print data of the RGB format is received, the printing apparatus 1101 executes the color conversion processing after rasterizing the print data.

In the step S1405, the trapping processing unit 1105 executes the trapping processing on the intermediate drawing data (intermediate data) based on the information related to the trapping processing, which is acquired in the step S1401. With this, the intermediate drawing data is generated as data having been subjected to the trapping processing based on the trapping setting (generation control step). This intermediate drawing data having been subjected to the trapping processing is stored in the shared information 208. Further, the trapping processing unit 1105 edits the trapping width in the print setting information to “none” or deletes the trapping setting from the print setting information. After execution of the step S1405, the process sequentially proceeds to the steps S1017 to S1020. In the step S1018, the intermediate drawing data subjected to the trapping processing is transmitted from the shared information 208 to the printing apparatus 1101 (transmission step). Then, a printed matter is obtained in the step S1020 as a printed matter subjected to the trapping processing.

As described above, in the present embodiment, even in a case where the trapping processing cannot be executed by the printing apparatus 1101, the extension application 1102 can execute the trapping processing. This makes it possible for even the printing apparatus 1101 as described above to print a printed matter on which execution of the trapping processing is reflected.

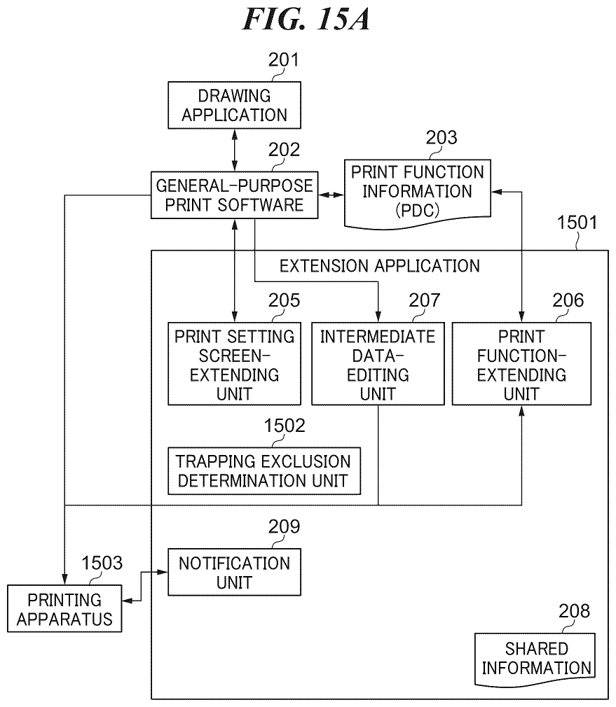

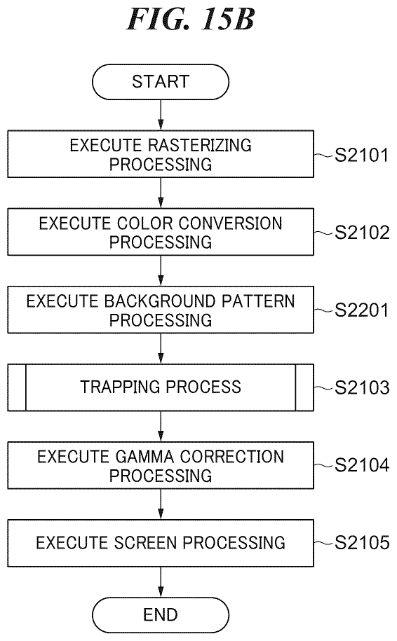

A third embodiment will be described below with reference to FIGS. 15A to 18, but the description will be given mainly of different points from the above-described embodiments, and description of the same points is omitted. The trapping processing sometimes has adverse effects on a printed matter due to its characteristics that a color plate not present in the target pixels is added. Processing performed before the trapping processing includes, for example, background pattern processing. The background pattern processing refers to processing for adding, to print data, background part formed by dots so small as to be incapable of being reproduced by copying using a printing apparatus and latent image part formed by dots so large as to be capable of being reproduced even by copying using the printing apparatus. By printing the background part and the latent image part with the same density setting, it is possible to realize a phenomenon that the background pattern cannot be visually recognized on a printed matter as the original, but the background pattern appears in a copy of the original. In a case where the trapping processing adds another color plate to the small dots, added in advance, of the background part, a difference in density between the background part and the latent image part can be made conspicuous. Alternatively, the small dots of the background part become dark, whereby the small dots of the background part can be reproduced even by copying.

To solve this problem, in the present embodiment, the extension application holds trapping exclusion setting information for excluding the trapping processing in advance. After receiving a print instruction, the extension application compares the print setting and the trapping exclusion setting information and notifies a user of a result of this comparison. This makes it possible to provide the trapping function while preventing an adverse effect of the trapping processing.

FIG. 15A is a block diagram showing a software configuration of the printing system 1000 according to the third embodiment. The block diagram shown in FIG. 15A is a diagram showing a configuration in a case where an extension application 1501 is associated with the general-purpose print software 202 and a printing apparatus 1503. As shown in FIG. 15A, the host computer 101 includes the drawing application 201, the general-purpose print software 202, the print function information 203, and the extension application 1501. Further, the extension application 1501 is communicably connected to the printing apparatus 1503. The printing apparatus 1503 is configured to be capable of executing the background pattern processing. The extension application 1501 includes the print setting screen-extending unit 205, the intermediate data-editing unit 207, the shared information 208, the notification unit 209, the print function-extending unit 1103, and a trapping exclusion determination unit 1502. The trapping exclusion determination unit 1502 is configured to compare the trapping exclusion setting information and the print settings, and request display of a warning as a result of the comparison on the print setting screen.

FIG. 15B is a flowchart of an imaging process performed by the printing apparatus 1503. In the imaging process in FIG. 15B, a step S2201 is added to the imaging process shown in FIG. 2B. Referring to FIG. 15B, after execution of the step S2102, the process proceeds to the step S2201. In the step S2201, the printing apparatus 1503 executes the above-described background pattern processing on the image data subjected to the color conversion processing in the step S2102. After execution of the step S2201, the process proceeds to the step S2103.

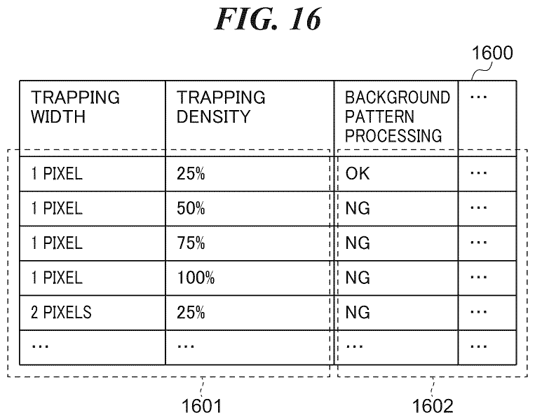

FIG. 16 is a diagram showing an example of a list of the trapping exclusion setting information. A table 1600 shown in FIG. 16 shows a relationship between the trapping width, the trapping density, and the background patten processing. Specifically, values of the trapping width and values of the trapping density are surrounded by a broken line 1601, and results of determination of whether or not the background patten processing can be executed, which is determined according to each set of a value of the trapping width and a value of the trapping density, are surrounded by a broken line 1602. For example, in a case where the trapping width is “1 pixel”, and the trapping density is “25%”, the background pattern processing can be executed and is recommended. This is because in a case where the trapping density to be added to the target pixel by the trapping processing is very low, the adverse effect on the background pattern dots is small. Further, in a case where the trapping width is “1 pixel”, and the trapping density is “50%”, execution of the background pattern processing is not recommended. This is because as the trapping density becomes higher, the influence on the background pattern dots becomes larger.

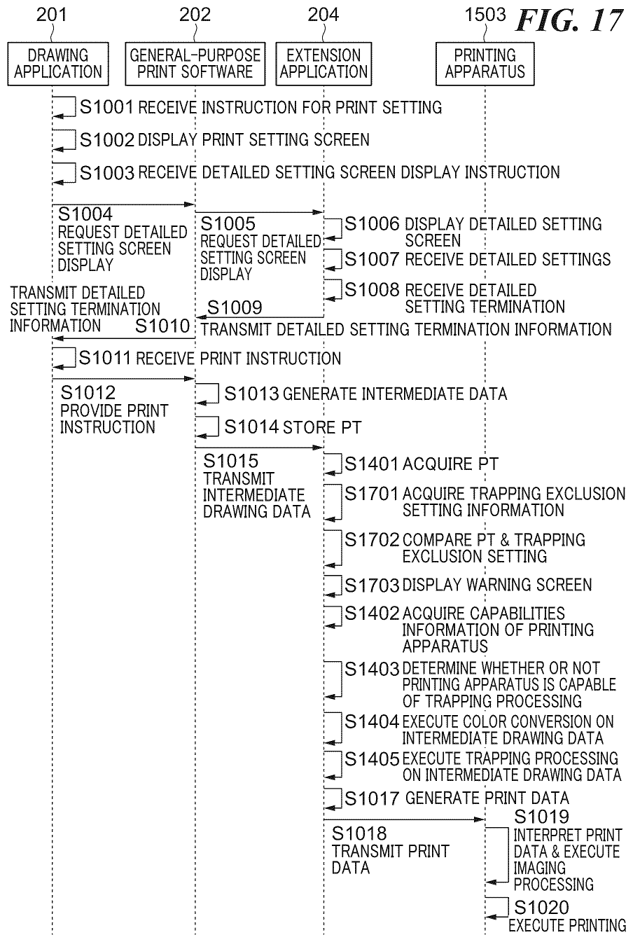

FIG. 17 is a sequence diagram showing a process executed between the drawing application 201, the general-purpose print software 202, the extension application 204, and the printing apparatus 1503, after the drawing application 201 receives print settings. The sequence diagram in FIG. 17 is configured mainly by adding steps S1701 to S1703 to the sequence diagram shown in FIG. 14. As shown in FIG. 17, after execution of the step S1401, the process proceeds to the step S1701. In the step S1701, the trapping exclusion determination unit 1502 of the extension application 1501 acquires the print setting information and the trapping exclusion setting information from the shared information 208.

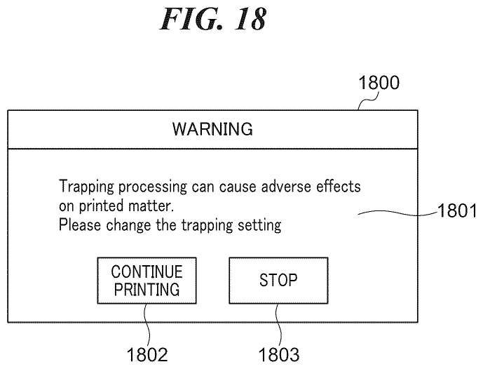

In the step S1702, the trapping exclusion determination unit 1502 determines whether or not to display a warning screen (notification screen) 1800, shown in FIG. 18, based on the print setting information and the trapping exclusion setting information, which are acquired in the step S1701. Note that details of the warning screen 1800 will be described hereinafter. Then, as a result of this determination, if it is determined that the warning screen 1800 is to be displayed, the trapping exclusion determination unit 1502 requests the print setting screen-extending unit 205 to display the warning screen 1800. Further, if it is determined that the warning screen 1800 is not to be displayed, the process proceeds to the step S1017.

In the step S1703, the print setting screen-extending unit 205 of the extension application 1501 displays warning screen 1800. With this display, an adverse effect of the trapping processing is notified according to the contents of a printed matter printed by the printing apparatus 1503 (notification step). Note that this notification step is executed between the display control step and the instruction step. After execution of the step S1703, the process sequentially proceeds to the steps S1402 to S1405, and the steps S1017 to S1020.

FIG. 18 is a diagram showing an example of a screen displayed on the display section of the printing system 1000. The warning screen 1800 shown in FIG. 18 is for notifying a user of an adverse effect of the trapping processing, according to the contents of a printed matter. The warning screen 1800 includes a message 1801, a control 1802, and a control 1803. On the message 1801, there are displayed a message to the effect that trapping processing can cause adverse effects on printed matter, and a message for prompting a user to change the trapping setting. By operating the control 1802, the user can instruct the printing apparatus 1503 to perform printing in a state in which the printed matter can be adversely affected by the trapping processing. In this case, the process proceeds to the step S1017. By operating the control 1803, the user can stop printing in the state in which the printed matter can be adversely affected by the trapping processing. In this case, the processing operations in the step S1017 et seq. are omitted. Thus, in the present embodiment, it is possible to perform the trapping setting while preventing an adverse effect of executing the trapping processing.

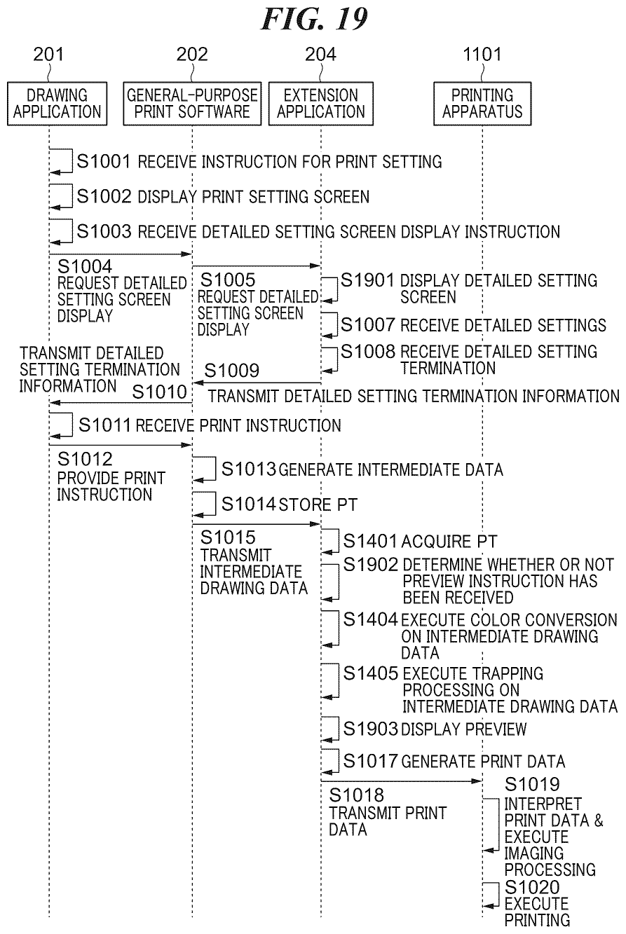

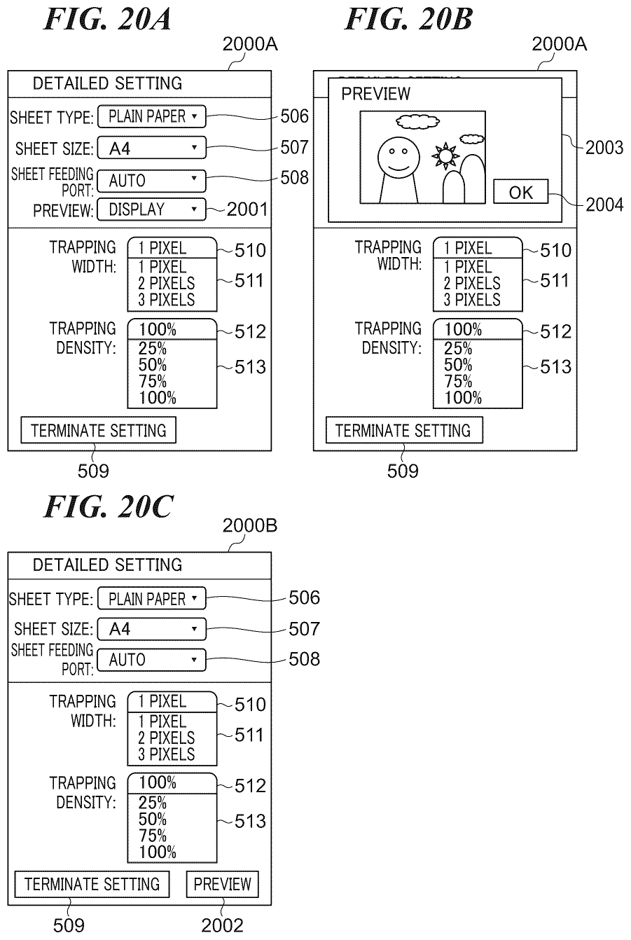

A fourth embodiment will be described below with reference to FIGS. 19 and 20, but the description will be given mainly of different points from the above-described embodiments, and description of the same points is omitted. In a case where color plate shift is not caused in a printing apparatus 1603, the trapping processing darkens a color of trapped pixels, whereby edge part is made conspicuous. In this case, there is a possibility that a printed matter is printed with an image quality not intended by the user. To prevent this, in the present embodiment, a result of the trapping processing can be displayed as the preview before printing.

FIG. 19 is a sequence diagram showing a process executed in the fourth embodiment between the drawing application 201, the general-purpose print software 202, the extension application 204, and the printing apparatus 1603, after the drawing application 201 receives print settings. The sequence diagram shown in FIG. 19 is configured by adding a step S1901 in place of the step S1006, and adding a step S1902 in place of the steps S1402 and S1403 to the sequence diagram shown in FIG. 14. Further, in the sequence diagram shown in FIG. 19, a step S1903 is added between the steps S1405 and S1017 to the sequence diagram shown in FIG. 14. FIGS. 20A to 20C are diagrams each showing an example of a screen displayed on the display section of the printing system 1000. Referring to FIG. 19, in the step S1901, the print setting screen-extending unit 205 of the extension application 1102 displays a detailed setting screen 2000A shown in FIG. 20A. The detailed setting screen 2000A is configured by adding a control 2001 to the detailed setting screen 500C shown in FIG. 5A-C. The control 2001 enables the user to select whether or not to display the preview.

In the step S1902, the print setting screen-extending unit 205 determines whether or not “display” has been selected for preview by the control 2001 on the detailed setting screen 2000A. As a result of this determination, if it is determined that “display” has been selected for preview, the color conversion processing unit 1104 executes the color conversion processing on the intermediate drawing data in the step S1404. Further, in the step S1405, the trapping processing unit 1105 executes the trapping processing on the intermediate drawing data.

In the step S1903, the print setting screen-extending unit 205 displays a preview image 2003 in the detailed setting screen 2000A as shown in FIG. 20B. The preview image 2003 is an image of the intermediate drawing data obtained after the trapping processing. This image is the same as an image of a printed matter printed by the printing apparatus 1603, on which the trapping processing has been reflected. With this preview image, the user can determine whether or not the printed matter is printed with an image quality not intended by the user. Further, as shown in FIG. 20B, the preview image 2003 includes a control 2004. By operating the control 2004, the detailed setting screen 2000A returns to the state shown in FIG. 20A. Then, in a case where “display” for preview on the control 2001 on the detailed setting screen 2000A in the state shown in FIG. 20A is canceled, and in a case where the control 509 is operated, the process executes the step S1402 et seq.

Alternatively, in place of the detailed setting screen 2000A, a detailed setting screen 2000B shown in FIG. 20C can be displayed. The detailed setting screen 2000B is a screen to which a control 2002 is added in place of the control 2001. By operating the control 2002, the user can instruct the preview display. Further, by operating the control 2002, the processing operations in the steps S1007 to S1903 can be executed.

According to the present disclosure, it is possible to cause the image forming apparatus to execute the trapping processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-165126, filed Sep. 24, 2024, which is hereby incorporated by reference herein in its entirety.

What is claimed is:

1. A non-transitory computer-readable storage medium storing an application program supporting a standard driver that is provided from a provider of an operating system and is incorporated in the operating system in advance,
wherein the application program causes a computer to execute:
a display control step for displaying a setting reception screen for receiving a setting of trapping processing for image data; and
an instruction step for instructing an image forming apparatus to execute the trapping processing based on the setting received on the setting reception screen.

2. The storage medium according to claim 1, wherein the application program causes the computer to execute a notification step between the display control step and the instruction step, for notifying a user of an adverse effect of the trapping processing according to contents of a printed matter to be printed by the image forming apparatus, and
wherein after execution of the notification step, execution of the instruction step can be stopped.

3. The storage medium according to claim 1, wherein the setting reception screen includes at least one of a width setting section for setting, as the setting, a width of trapping in an area of a plurality of colors, overlapped by the trapping processing, and a density setting section for setting, as the setting, a density of trapping in the area of the plurality of colors, overlapped by the trapping processing.

4. The storage medium according to claim 3, wherein the width setting section includes a plurality of widths, and one width can be selected from the plurality of widths, and
wherein the density setting section includes a plurality of densities, and one density can be selected from the plurality of densities.

5. The storage medium according to claim 1, wherein the setting reception screen includes a preview image of a printed matter to be printed by the image forming apparatus, on which the trapping processing has been reflected.

6. The storage medium according to claim 1, wherein whether or not to display the setting reception screen can be switched according to the image forming apparatus.

7. The storage medium according to claim 6, wherein the application program causes the computer to execute:
an acquisition step for acquiring, prior to the display control step, from the image forming apparatus, capabilities information related to capabilities of the image forming apparatus, for performing printing, and
a determination step for determining whether or not information which enables display of the setting reception screen is included in the capabilities information acquired in the acquisition step, and
wherein in the display control step, as a result of determination in the determination step, in a case where it is determined that the information which enables display of the setting reception screen is included, the setting reception screen is displayed, whereas in a case where it is determined that the information which enables display of the setting reception screen is not included, the setting reception screen is not displayed.

8. The storage medium according to claim 1, wherein a function of receiving the setting is a function which cannot be executed by the standard driver.

9. The storage medium according to claim 1, wherein as the standard driver, a program operating based on Internet Printing Protocol (IPP) is used.

10. A non-transitory computer-readable storage medium strong an application program supporting a standard driver that is provided from a provider of an operating system and is incorporated in the operating system in advance,
wherein the application program causes a computer to execute:
a display control step for displaying a setting reception screen for receiving a setting of trapping processing for image data;
a generation control step for generating image data on which the trapping processing has been performed based on the setting received on the setting reception screen; and
a transmission step for transmitting the image data generated in the generation control step to an image forming apparatus.

11. The storage medium according to claim 10, wherein the application program causes the computer to execute a notification step between the display control step and the transmission step, for notifying a user of an adverse effect of the trapping processing according to contents of a printed matter to be printed by the image forming apparatus, and
wherein after execution of the notification step, execution of the transmission step can be stopped.

12. The storage medium according to claim 10, wherein the setting reception screen includes at least one of a width setting section for setting, as the setting, a width of trapping in an area of a plurality of colors, overlapped by the trapping processing, and a density setting section for setting, as the setting, a density of trapping in the area of the plurality of colors, overlapped by the trapping processing.

13. The storage medium according to claim 12, wherein the width setting section includes a plurality of widths, and one width can be selected from the plurality of widths, and
wherein the density setting section includes a plurality of densities, and one density can be selected from the plurality of densities.

14. The storage medium according to claim 10, wherein the setting reception screen includes a preview image of a printed matter to be printed by the image forming apparatus, on which the trapping processing has been reflected.

15. The storage medium according to claim 10, wherein whether or not to display the setting reception screen can be switched according to the image forming apparatus.

16. The storage medium according to claim 15, wherein the application program causes the computer to execute:
an acquisition step for acquiring, prior to the display control step, from the image forming apparatus, capabilities information related to capabilities of the image forming apparatus, for performing printing, and
a determination step for determining whether or not information which enables display of the setting reception screen is included in the capabilities information acquired in the acquisition step, and
wherein in the display control step, as a result of determination in the determination step, in a case where it is determined that the information which enables display of the setting reception screen is included, the setting reception screen is displayed, whereas in a case where it is determined that the information which enables display of the setting reception screen is not included, the setting reception screen is not displayed.

17. The storage medium according to claim 10, wherein a function of receiving the setting is a function which cannot be executed by the standard driver.

18. The storage medium according to claim 10, wherein as the standard driver, a program operating based on Internet Printing Protocol (IPP) is used.

19. A method of performing control to support a standard driver that is provided from a provider of an operating system and is incorporated in the operating system in advance, comprising:
displaying a setting reception screen for receiving a setting of trapping processing for image data; and
instructing an image forming apparatus to execute the trapping processing based on the setting received on the setting reception screen.

20. A method of performing control to support a standard driver that is provided from a provider of an operating system and is incorporated in the operating system in advance, comprising:
displaying a setting reception screen for receiving a setting of trapping processing for image data;
generating image data on which the trapping processing has been performed based on the setting received on the setting reception screen; and
transmitting the image data generated by the generating to an image forming apparatus.

21. An information processing apparatus that has a standard driver that is provided from a provider of an operating system and is incorporated in the operating system in advance, and an application program supporting the standard driver,
wherein the application program causes a computer of the information processing apparatus to execute:
a display control step for displaying a setting reception screen for receiving a setting of trapping processing for image data; and
an instruction step for instructing an image forming apparatus to execute the trapping processing based on the setting received on the setting reception screen.

22. An information processing apparatus that has a standard driver that is provided from a provider of an operating system and is incorporated in the operating system in advance, and an application program supporting the standard driver,
wherein the application program causes a computer of the information processing apparatus to execute:
a display control step for displaying a setting reception screen for receiving a setting of trapping processing for image data;
a generation control step for generating image data on which the trapping processing has been performed based on the setting received on the setting reception screen; and
a transmission step for transmitting the image data generated in the generation control step to an image forming apparatus.
